(19) United States
(12) Patent Application Publication
(10) Pub. No.: US 2014/0343949 A1
(43) Pub. Date: Nov. 20, 2014

(54) SMART MICROPHONE DEVICE

(71) Applicant: Fortemedia, Inc., Sunnyvale, CA (US)

(72) Inventors: Yen-Son Paul HUANG, Los Altos Hills, CA (US); Iou-Din Jean CHEN, San Jose, CA (US); Edward DENG, Sunnyvale, CA (US); Lung-Chu Joseph CHEN, Pleasanton, CA (US)

(73) Assignee: Fortemedia, Inc., Sunnyvale, CA (US)

(21) Appl. No.: 13/948,840

(22) Filed: Jul. 23, 2013

Related U.S. Application Data
(60) Provisional application No. 61/824,567, filed on May 17, 2013.

(51) Int. Cl. G10L 25/48; H04R 1/08

(52) U.S. Cl. CPC G10L 25/48; H04R 1/08
USPC 704/275

(57) ABSTRACT

A smart microphone device is provided. The smart microphone device is coupled to a host, and includes: an analog microphone unit, receiving sounds; a voice detection unit, coupled to the analog microphone unit, detecting voices from the sounds; a speech detection unit, coupled to the voice detection unit, detecting a speech from the voices; and a channel select pin, coupled between the smart microphone device and the host, wherein an interrupt signal is sent from the smart microphone device to the host via the channel select pin to enable the host to operate in the normal mode when the speech detection unit detects the speech.

### CROSS REFERENCE TO RELATED APPLICATIONS

This application claims the benefit of U.S. Provisional Application No. 61/824,567, filed on May 17, 2013, the entirety of which is incorporated herein by reference.

### BACKGROUND OF THE INVENTION

1. Field of the Invention

The present invention relates to speech interface technology, and in particular, relates to using the smart microphone equipped with speech recognition technology to wake the host in order to save total system power consumption.

2. Description of the Related Art

A microphone is a transducer which can capture voices and sounds and convert them into electronic signals. Nowadays, digital microphones are commonly applied in mobile devices

For a typical design, there are five pins configured between a digital microphone and a host, including a power pin (i.e., VDD pin), a ground pin (i.e., GND pin), a channel select pin (i.e., CS pin), a data pin (i.e., DATA pin) and a clock input pin (i.e., CLK pin). The operation states of the digital microphone are completely controlled by a host through the pins. When the host continually supplies the clock input via the CLK pin to the microphone, the microphone can operate in a normal state. When the host operates in a standby mode (or sleep mode) or does not need the information from the microphone, the host stops providing the clock input to the microphone and the microphone enters into the standby mode (or sleep mode) to save power.

However, the digital microphone in the prior art cannot wake up the host.

### BRIEF SUMMARY OF THE INVENTION

To overcome the deficiencies in the prior art, the present invention provides a smart microphone device. The smart microphone device of the present invention is always on for detecting the voices, so that it is not necessary for the host to resume from the standby mode (or sleep mode) to utilize the functions of the microphones, thus reducing the power consumption of the host.

The smart microphone device of the present invention is coupled to a host, and comprises: an analog microphone unit, receiving sounds; a voice detection unit, coupled to the analog microphone unit, detecting voices from the sounds; a speech detection unit, coupled to the voice detection unit, detecting a speech from the voices; and a channel select pin, coupled between the smart microphone device and the host, wherein an interrupt signal is sent from the smart microphone device to the host via the channel select pin to enable the host to operate in the normal mode when the speech detection unit detects the speech.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A and FIG. 1B show schematic diagram of a smart microphone device according to an embodiment of the present inventions.

FIG. 2 shows the smart microphone device 100 and the host 200 in the normal mode.

FIG. 3 shows the smart microphone device 100 and the host 200 during the voice detection procedure.

FIG. 4 shows the smart microphone device 100 and the host 200 during the speech detection procedure.

FIG. 5 shows the smart microphone device 100 and the host 200 during the waking-up procedure.

FIG. 6 shows a microphone array having two smart microphone devices according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

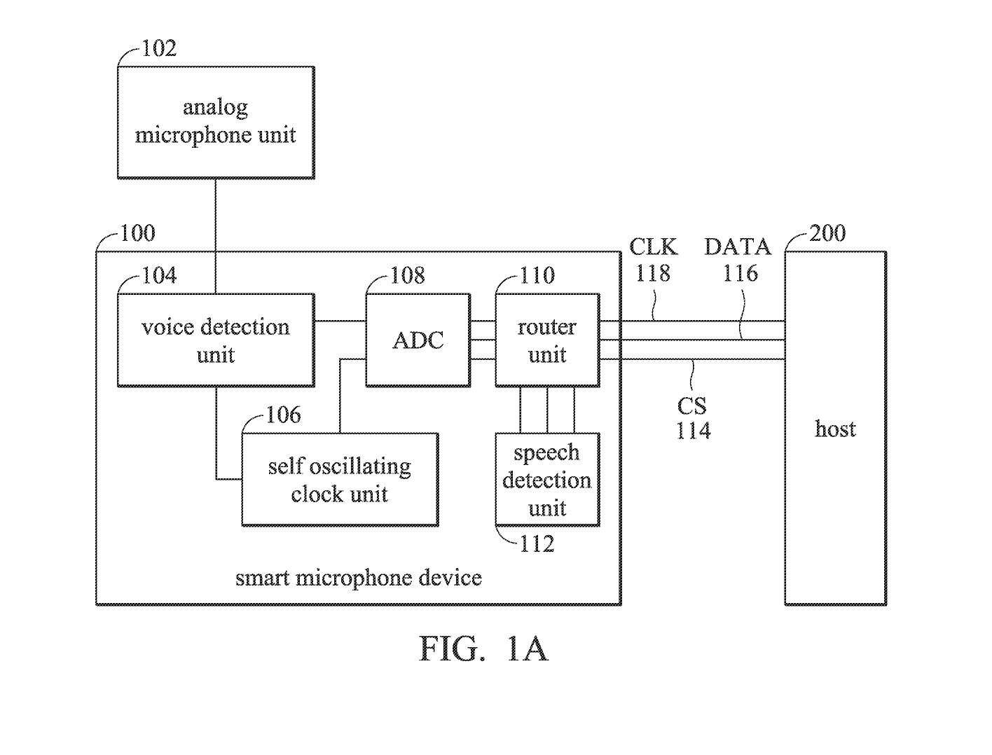

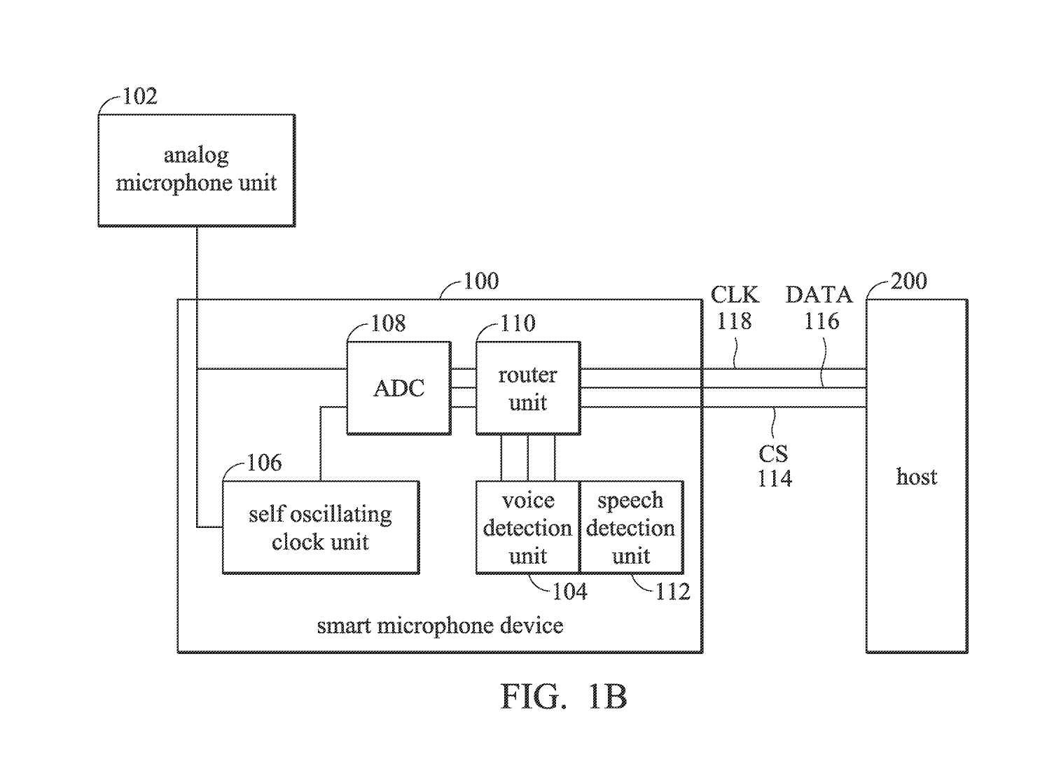

FIG. 1A shows a schematic diagram of a smart microphone device according to an embodiment of the present invention; while FIG. 1B shows a schematic diagram of a smart microphone device according to another embodiment of the present inventions. The smart microphone device 100 of the present invention is coupled to a host 200, and the host 200 can enable the smart microphone device to operate in either a normal mode or a standby mode. The smart microphone device 100 comprises: an analog microphone unit 102, a voice detection unit 104, a self oscillating clock unit 106, an analog-to-digital converter (ADC) 108, a router unit 110, and a speech detection unit 112. In this embodiment, the smart microphone 100 is coupled to the host 200 via five pins, which include: a channel select pin 114, a data pin 116, a clock input pin 118, a power pin (not shown) and a ground pin (not shown). These components will be further described in the following description.

Please refer to FIG. 1. The analog microphone unit 102 is configured to receive sounds. In the present invention, the sounds received by the unit 102 are initially in analog form, and consist of voices made by human beings and some other noises from the environment. The voice detection unit 104 is coupled to the analog microphone unit 102 and configured to detect the voices from the sounds. The self oscillating clock unit 106 is coupled to the voice detection unit 104. The self oscillating clock unit 106, in a particular situation, can produce an oscillating clock signal for the smart microphone device 100 when the voice detection unit 104 detects the voices. The ADC 108 is coupled between the analog microphone unit 102 and the host 200, and configured to convert the analog sounds and voices from the analog form into digital form, and provide the digital data to the host 200. The speech detection unit 112 of the present invention is a digital signal processor (DSP), which can process the digital data that is transmitted from the analog-to-digital converter 108, and analyze the digital data to determine if the digital data of the voices constitute a specific speech (language). This procedure will be further described later. The router unit 110 is coupled to the ADC 108, the speech detection unit 112 and the host 200 for transmitting information among them.

The smart microphone device is, most of the time, controlled by the host 200. Through the pins coupled between the host 200 and the smart microphone device 100, the host 200 can control and enable the smart microphone device 100 to operate in either the normal mode or the standby mode.

### Normal Mode

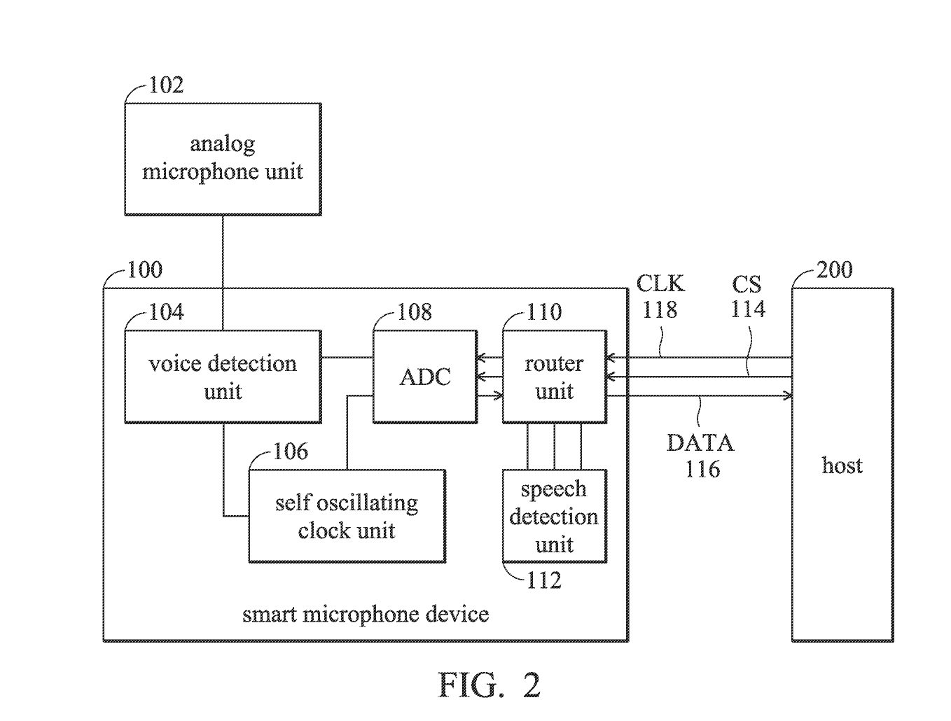

FIG. 2 shows the smart microphone device 100 and the host 200 in the normal mode. In the normal mode, the host 200 continually provides the clock signal to the smart microphone device 100 via the clock input pin 118 (as shown in FIG. 2, the clock signal is labeled with an arrow which points to the smart microphone device 100), and thus the smart microphone device 100 performs normal microphone functions. Specifically, the router unit 110 couples the host 200 to the ADC 102 and further to the analog microphone unit 102, thus providing the clock signal from the host 200 to the smart microphone device 100. Therefore, the analog microphone unit 102 detects the sounds, and the analog-to-digital converter 108 provides the digital data of the sounds to the host 200 via the data pin (as shown in FIG. 2, the data is labeled with an arrow which points to the host 200). In this mode, due to the existing clock input from the host 200, it is not necessary for the self oscillating clock unit 106 to provide the other clocks. Therefore, the self oscillating clock unit 106 is inactive. However, the voice detection unit 104 and the speech detection unit 112 can still remain active for other purposes which will be described later. In the present invention, the host 200 can notify the smart microphone device 100 via the channel selection pin 114 that the host 200 will soon enter the sleep mode or the standby mode. And then, the host 200 stops providing the clock signal and makes the entire smart microphone device 100 enter the standby mode.

### Standby Mode

Similar to the prior art, the microphone device 100 enters the standby mode when the host 200 enters the standby mode (or the sleep mode). However, it is different from the prior art in that the smart microphone device 100 of the present invention can resume by itself and then wake up the host 200. In the standby mode, the smart microphone device 100 of the present invention can operate with three procedures: 1. A voice detection procedure; 2. A speech detection procedure; and 3. A waking-up procedure.

### Voice Detection Procedure

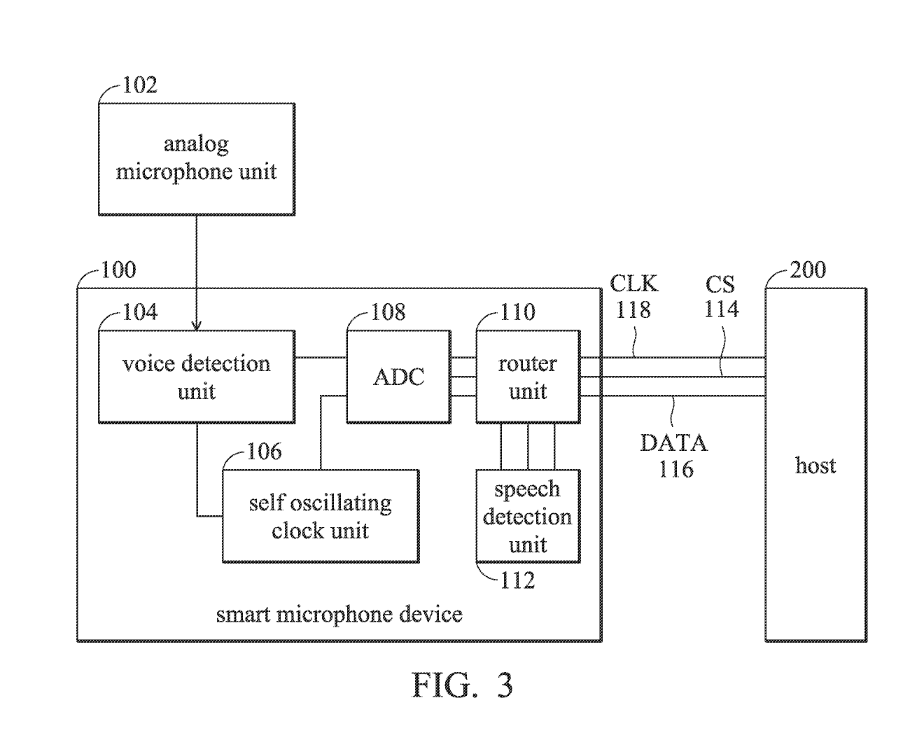

FIG. 3 shows the smart microphone device 100 and the host 200 during the voice detection procedure. In this procedure, the analog microphone unit 102 is active, while the self oscillating clock unit 106, the ADC 108, the speech detection unit 112 and the router unit 110 could be active or inactive. On the one hand, the router unit 110 stays active and waits for the clock signals from the host 200. If the host 200 resumes from the standby mode (or the sleep mode) in this procedure, it provides the clock signals to the smart microphone device 100 via the clock input pin 118 and the router unit 110, thus waking up the smart microphone device 100. On the other hand, the voice detection unit 104 can perform the voice detection function upon recognition of sounds received by the analog microphone unit 102, for example, through inspecting the amplitude and/or the accumulated energy of the sounds. If the voice detection unit 104 in this procedure detects the voices within a pre-defined period of time and frequency band, it enables the smart microphone device 100 to implement the speech detection procedure. In an embodiment, when the voice detection unit 104 does not detect the voices, the self oscillating clock unit 106, the ADC 108, and the speech detection unit 112 stay inactive. However, in another embodiment as shown in FIG. 1B, the voice detection unit 104 is tightly coupled to the speech detection unit 112. When the host 200 stops sending clock to the smart microphone device 100, the self oscillating clock unit 105 is enabled to operate in a power saving mode to provide the self oscillating clocks at a slower speed, and the ADC 108 will operate in a lower SNR mode to save power.

### Speech Detection Procedure

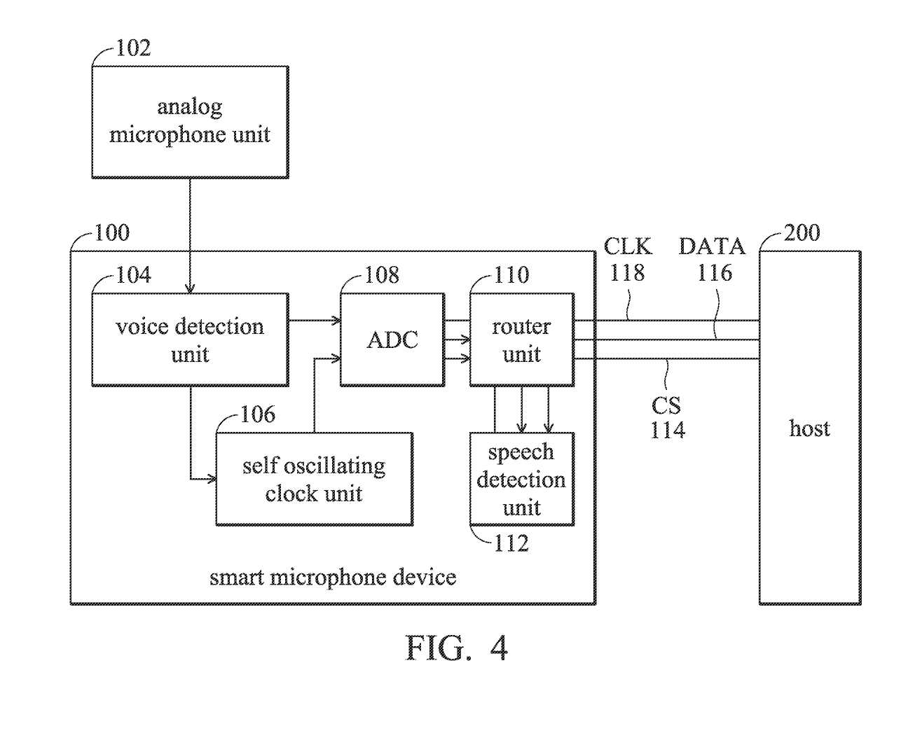

FIG. 4 shows the smart microphone device 100 and the host 200 during the speech detection procedure. In this procedure, after detecting the voices, the voice detection unit 104 activates the self oscillating clock unit 106 so that the self oscillating clock unit 106 can start to supply an internal oscillating clock signal to the entire smart microphone device 100, especially the ADC 108 and the speech detection unit 112. The ADC 108 is active, and converts the voices into digital data. The digital data is then provided to the speech detection procedure 112 through the router unit 110, and the speech detection procedure 112 performs the speech detection function upon the digital data to recognize if the voices constitute a specific speech. In an embodiment, a plurality of pre-defined phrases of speech can be pre-stored in a memory of the smart microphone device 100. In another embodiment, the pre-defined phrases can be customized by the users and downloaded to the memory of the smart microphone device 100 via the channel selection pin 114 (the clock input pin 118 is active for synchronous download; and inactive for asynchronous download). And then, the speech detection unit 112 can thus recognize if the voices match any of the pre-defined phrases. If there is no speech detected, the smart microphone device 100 goes back to the voice detection procedure, and if any specific speech is detected, the smart microphone device 100 implements the waking-up procedure.

### Waking-Up Procedure

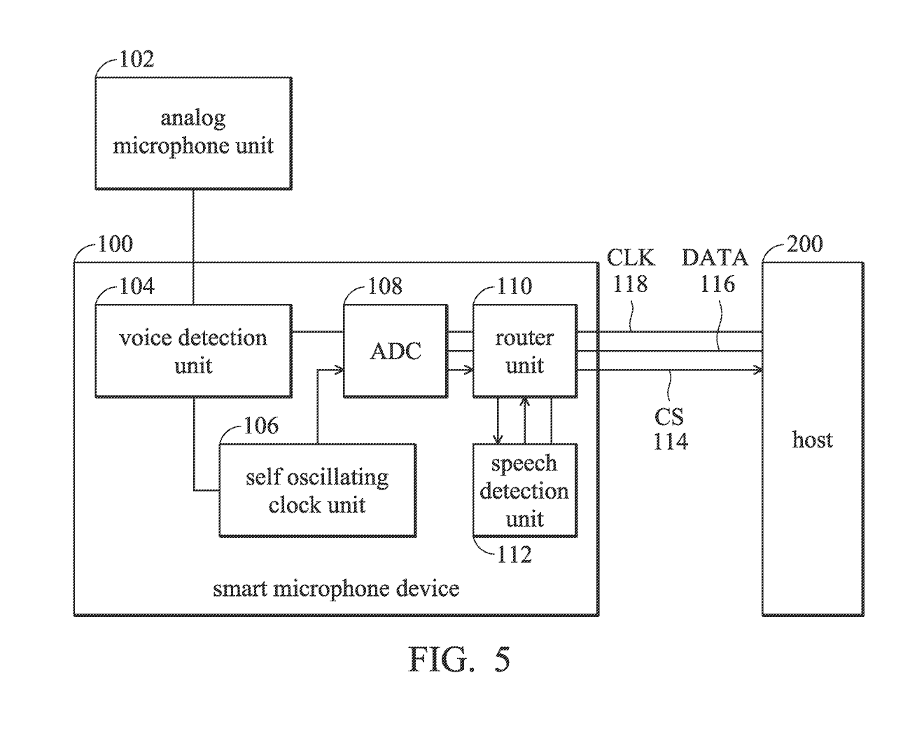

FIG. 5 shows the smart microphone device 100 and the host 200 during the waking-up procedure. After detecting the speech, the speech detection unit 112 sends an interrupt signal to the host 200 via the channel selection pin 114 or DATA pin 116 to wake up the host 200 and notify the host 200 that speech has been detected. Then, the host 200 resumes operation and sends the clock signal via the clock input pin 118 to the smart microphone device 100, so that the smart microphone device 100 enters the normal mode. Note that the channel selection pin in the present invention is a bi-directional pin. The channel selection pin in the prior art always stays idle when the host operates in the standby mode (or sleep mode). However, by sufficiently using the channel selection pin in the standby mode (or sleep mode), the present invention can achieve this effect.

In the normal mode, as described above, the voice detection unit 104 and the speech detection unit 112 can remain active for other purposes. Similarly, the voice detection unit 104 performs the voice detection function and the speech detection unit 112 performs the voice detection function. In a preferred embodiment, when the smart microphone device 100 receives voices from a user and recognizes that there is an audio command (or request) in the voices, the speech detection unit 112 can further transmit the recognized data (detected speech) to the host 200 through the router unit 110 and the data pin 116, and the host 200 can further process the recognized data and perform various actions according to the recognized data.

### Other Functions

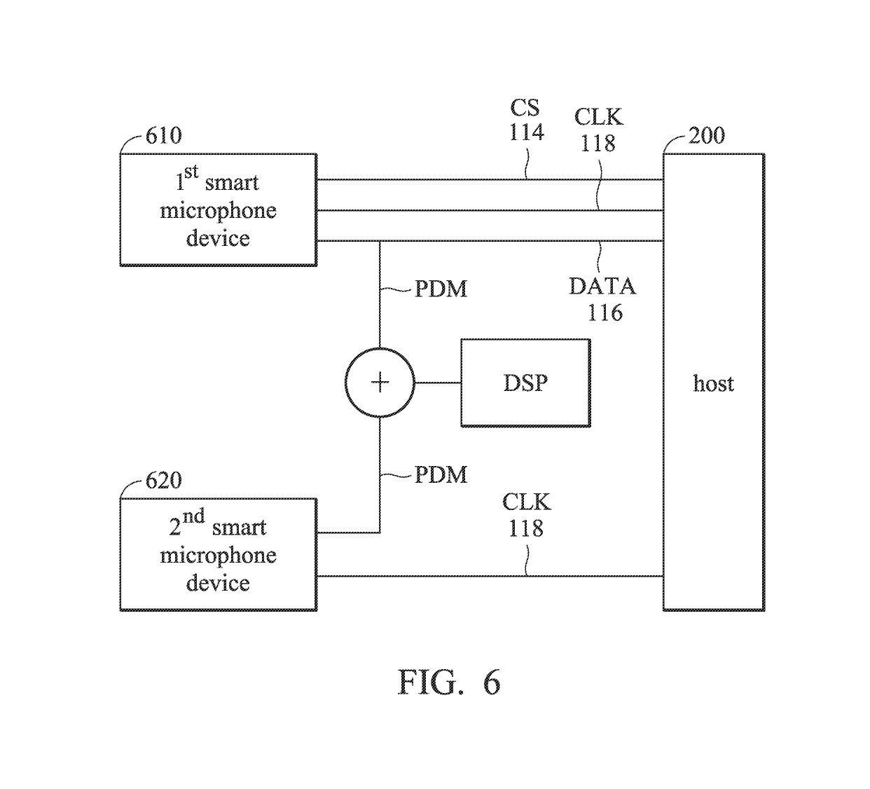

In some embodiments, the speech detection unit 112 is included in a digital signal processor (DSP), and the DSP can additionally install noise cancelling programs for eliminating the noises from the environment. The noises can be eliminated before the speech detection unit 112 performs the speech detection function, thus, indirectly enhancing the recognition rate. It should be noted, in yet some embodiments, the present invention can be applied to a microphone array which consists of any number of the smart microphone devices described above. FIG. 6 shows a microphone array having two smart microphone devices according to an embodiment of the present invention. In this embodiment, the smart microphone devices 610 and 620, respectively, comprise the analog microphone unit, the voice detection unit, the self oscillating clock unit, the ADC and the router unit, as described above, and share the same DSP (or speech detection unit) for simplicity. The data from the two microphone devices can be merged by a PDM pin and then integrated by the DSP. Through the functions and arrangements described above, the smart microphone devices of the present invention can achieve better voice communication and recognition functions.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A smart microphone device, coupled to a host, comprising:
an analog microphone unit, for receiving sounds;
a voice detection unit, for detecting voices from the sounds;
a speech detection unit, for detecting a speech from the voices;
wherein the smart microphone device sends an interrupt signal to the host to enable the host to operate in the normal mode when the speech detection unit detects the speech.

2. The smart microphone device as claimed in claim 1, further comprising:
a self oscillating clock unit, producing an oscillating clock signal for the smart microphone device.

3. The smart microphone device as claimed in claim 1, further comprising:
an analog-to-digital converter (ADC), converting the sounds and voices from the analog form into digital form, wherein the ADC has two modes, and the ADC operates in high SNR in the normal mode; and operates in lower SNR for power saving in a standby mode.

4. The smart microphone device as claimed in claim 3, further comprising:
a router unit, coupled among the ADC, the speech detection unit and the host, for transmitting information thereamong.

5. The smart microphone device as claimed in claim 1, wherein the host enables the smart microphone device to operate in a normal mode by sending a clock signal to the smart microphone device.

6. The smart microphone device as claimed in claim 5, wherein the host enables the smart microphone device to operate in a standby mode by stopping the sending of the clock signal to the smart microphone device.

7. The smart microphone device as claimed in claim 1, wherein when the smart microphone device operates in a normal mode, the speech detection unit transmits the detected speech to the host through a data pin.

8. The smart microphone device as claimed in claim 1, wherein when the host is in a standby mode, the speech detection unit transmits the detected speech to the host through a data pin and serves as an interrupt to wake up the host.

9. The smart microphone device as claimed in claim 1, wherein when the host is in a standby mode, the smart microphone device sends an interrupt signal via CS pin to wake up the host when the speech detection unit detects pre-defined phrase.

10. The smart microphone device as claimed in claim 7, wherein when the speech detection unit transmits the detected speech to the host, the host processes the detected speech and performs various actions according to the detected speech.

11. The smart microphone device as claimed in claim 1, wherein the speech detection unit detects the speech by recognizing if the voices match pre-defined phrases of the speech.

12. The smart microphone device as claimed in claim 11, the pre-defined phrases of the speech can be downloaded into memory of the smart microphone device via CS pin.

13. The smart microphone device as claimed in claim 11, wherein the pre-defined phrases of the speech are pre-stored in a memory of the smart microphone device.

14. The smart microphone device as claimed in claim 1, wherein the voice detection unit detects the voice by inspecting the amplitude and/or the accumulated energy of the sounds within a pre-defined period of time and frequency band.

15. The smart microphone device as claimed in claim 1, wherein the speech detection unit eliminates the noises from the sounds when detecting the speech.

16. The smart microphone device as claimed in claim 1, can be further connected or integrated with at least one microphone device to form a smart microphone array.
